(19) United States
(12) Patent Application Publication
(10) Pub. No.: US 2013/0282731 A1
(43) Pub. Date: Oct. 24, 2013

(54) INFORMATION SEARCH DEVICE

(71) Applicant: Takeshi Arikuma, Tokyo (JP)

(72) Inventor: Takeshi Arikuma, Tokyo (JP)

(73) Assignee: NEC CORPORATION, Tokyo (JP)

(21) Appl. No.: 13/978,466

(22) PCT Filed: Nov. 30, 2011
(86) PCT No.: PCT/JP2011/006677

§ 371 Date: Jul. 5, 2013

(30) Foreign Application Priority Data
Jan. 25, 2011 (JP) 2011-012711

(51) Int. Cl. G06F 17/30

(52) U.S. Cl. CPC G06F 17/30424
USPC 707/741

(57) ABSTRACT

An information search device in accordance with the present invention is configured such that a search request acceptance means accepts, object search condition information and associated information search condition information while a search means stores, into the main storage portion from the data storage portion, the index of the analysis object information including the analysis object corresponding to the object search condition information, and the index of the associated information including the associated information corresponding to the associated information search condition information, searches for the analysis object identified by the object search condition information from the main storage portion and stores, into the main storage portion, the index associating the associated information with the analysis object information corresponding to the searched analysis object, and searches for the information corresponding to the search condition information from the respective indexes stored in the main storage portion.

### TECHNICAL FIELD

The present invention relates to information search devices searching for desired information from analytical data.

### BACKGROUND ART

In a security system such as that carrying out motion line analysis of a person to search for the characteristics of the person in a predetermined place, there are many cases of accumulating a large amount of analytical data analyzed by a predetermined analytical engine to carry out complicated searches on the large amount of data. However, when carrying out such kind of searches on a large amount of data, although it is necessary to once store the data of the search objects into a main storage device, it is difficult to keep the large amount of data in the main storage device at one time if the capacity of the main storage device is limited. This, therefore, gives rise to a problem that a large number of inputs and outputs of data occur between the main storage device, and the storage device storing the analytical data; as a result, the search performance degrades significantly.
Patent Document 1: JP 11-31148 A

Hence, there is a disclosure in Patent Document 1 of a technique for improving information search processing speed. The technique of Patent Document 1 deploys the index data of a key word in the main storage device in descending order of the number of references to the key word in the past.

However, the above system gives rise to such a problem that although it is effective in improving the search processing speed for the case of searching again with a key word which was used many times in searches of the past, a high-speed search still cannot be performed for a search request with a key word which is used in a search for the first time. Especially, when carrying out a search on a large amount of analytical data as described above, there are many occasions of searching for information with a specific condition, and thus first-time searches often happen. Therefore, the problem, as described above, that high-speed searches cannot be performed, becomes conspicuous.

### SUMMARY

Hence, an exemplary object of the present invention is to solve the above problem of the decrease in search speed at the time of searching on analytical data.

In order to achieve the above exemplary object, an aspect of the present invention provides an information search device including:

a data storage portion having stored an index of analysis object information, an index of associated information which is a predetermined analysis result for each analysis object, and an index associating the analysis object information with the associated information of the analysis object;

a main storage portion temporarily storing the respective indexes read out from the data storage portion;

a search request acceptance means for accepting search condition information denoting a search request of the information to be searched for from the data storage portion; and

a search means for reading out at least some of the respective indexes from the data storage portion to store the same into the main storage portion based on the search condition information, and searching for the information corresponding to the search condition information from the respective indexes stored in the main storage portion.

Then, the search request acceptance means accepts, as the search condition information, object search condition information which is the condition for identifying the analysis object, and associated information search condition information which is the condition for identifying the associated information, while the search means stores, into the main storage portion from the data storage portion, the index of the analysis object information including the analysis object corresponding to the object search condition information, and the index of the associated information including the associated information corresponding to the associated information search condition information; searches for the analysis object identified by the object search condition information from the main storage portion and stores, into the main storage portion, the index associating the associated information with the analysis object information corresponding to the searched analysis object; and searches for the information corresponding to the search condition information from the respective indexes stored in the main storage portion.

Further, another aspect of the present invention provides a computer program including instructions for causing an information processing device to realize a function,

the information processing device including:

a data storage portion having stored an index of analysis object information, an index of associated information which is a predetermined analysis result for each analysis object, and an index associating the analysis object information with the associated information of the analysis object; and

a main storage portion temporarily storing the respective indexes read out from the data storage portion,

the function including:

a search request acceptance means for accepting search condition information denoting a search request of the information to be searched for from the data storage portion; and

a search means for reading out at least some of the respective indexes from the data storage portion to store the same into the main storage portion based on the search condition information, and searching for the information corresponding to the search condition information from the respective indexes stored in the main storage portion,

wherein the search request acceptance means accepts, as the search condition information, object search condition information which is the condition for identifying the analysis object, and associated information search condition information which is the condition for identifying the associated information,

wherein the search means stores, into the main storage portion from the data storage portion, the index of the analysis object information including the analysis object corresponding to the object search condition information, and the index of the associated information including the associated information corresponding to the associated information search condition information; searches for the analysis object identified by the object search condition information from the main storage portion and stores, into the main storage portion, the index associating the associated information with the analysis object information corresponding to the searched analysis object; and searches for the information corresponding to the search condition information from the respective indexes stored in the main storage portion.

Further, still another aspect of the present invention provides an information search method for the use of an information processing device including a data storage portion having stored an index of analysis object information, an index of associated information which is a predetermined analysis result for each analysis object, and an index associating the analysis object information with the associated information of the analysis object, and a main storage portion temporarily storing the respective indexes read out from the data storage portion, the method including:

accepting object search condition information which is the condition for identifying the analysis object, and associated information search condition information which is the condition for identifying the associated information, as search condition information denoting a search request of the information to be searched for from the data storage portion; and

storing, into the main storage portion from the data storage portion, the index of the analysis object information including the analysis object corresponding to the object search condition information, and the index of the associated information including the associated information corresponding to the associated information search condition information, searching for the analysis object identified by the object search condition information from the main storage portion and storing, into the main storage portion, the index associating the associated information with the analysis object information corresponding to the searched analysis object, and searching for the information corresponding to the search condition information from the respective indexes stored in the main storage portion, when reading out at least some of the respective indexes from the data storage portion to store the same into the main storage portion based on the search condition information, and searching for the information corresponding to the search condition information from the respective indexes stored in the main storage portion.

By taking the above configuration, the present invention is capable of facilitating improvement in the search speed on analytical data.

### BRIEF DESCRIPTION OF DRAWINGS

FIG. 1 is a block diagram showing a configuration of an information search device in accordance with a first exemplary embodiment of the present invention;

FIG. 2 shows an example of the data storage portion disclosed in FIG. 1;

FIG. 3 shows an example of an index-segment sequence table stored in the index information database disclosed in FIG. 1;

FIG. 4A shows an example of a segment sequence index stored in the index information database disclosed in FIG. 1;

FIG. 4B shows another example of the segment sequence index stored in the index information database disclosed in FIG. 1;

FIG. 4C shows still another example of the segment sequence index stored in the index information database disclosed in FIG. 1;

FIG. 4D shows still another example of the segment sequence index stored in the index information database disclosed in FIG. 1;

FIG. 5 is a flowchart showing an operation of the information search device disclosed in FIG. 1;

FIG. 6 is a flowchart showing part of the operation of the information search device disclosed in FIG. 1;

FIG. 7 is an explanatory diagram showing an aspect of the operation in searching by the information search device disclosed in FIG. 1; and

FIG. 8 is a block diagram showing a configuration of an information search device in accordance with Supplementary Note 1 of the present invention.

### EXEMPLARY EMBODIMENT

### A First Exemplary Embodiment

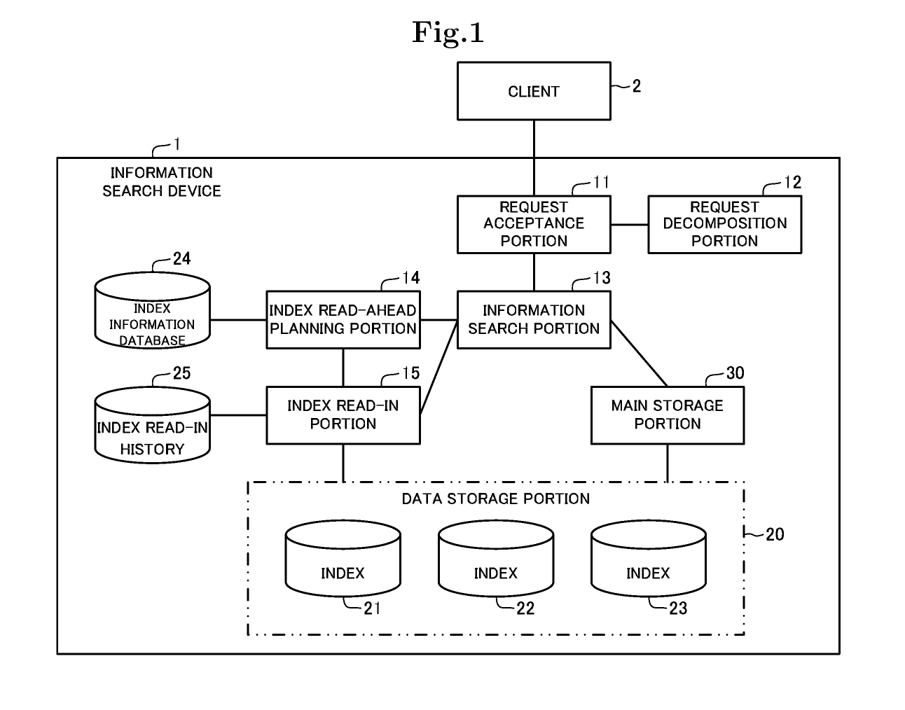

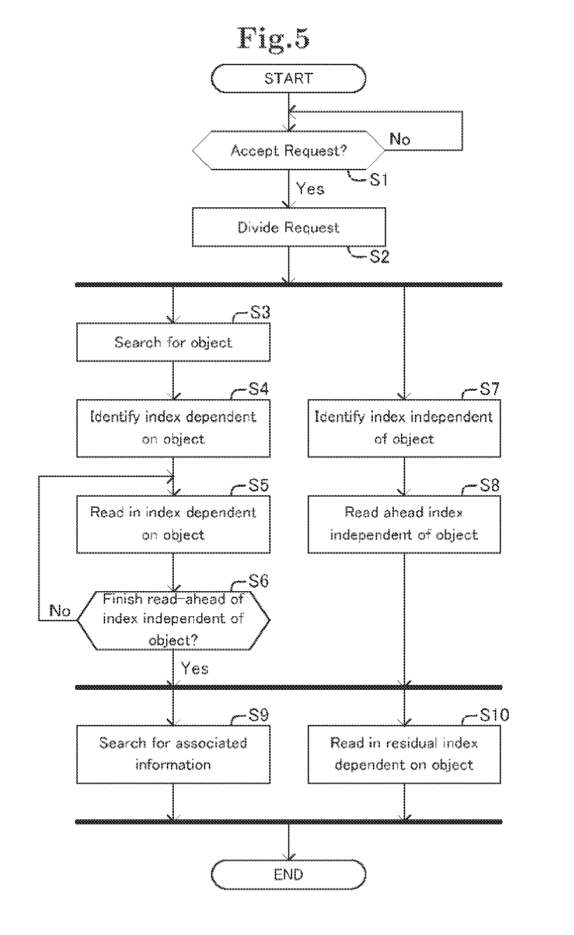

Referring to FIGS. 1 through 7, a first exemplary embodiment of the present invention will be explained. FIGS. 1 through 4 show a configuration of an information search device, while FIGS. 5 through 7 show an operation of the information search device.

[Configuration]

An information search device 1 in accordance with the present invention is an information processing device including a computation device and a storage device, and has a function of searching for the data satisfying a requested condition from the analytical data analyzed by a predetermined analytical engine. Therefore, the information search device 1 has the following configuration as shown in FIG. 1.

First, the information search device 1 includes a request acceptance portion 11, a request decomposition portion 12, an information search portion 13, an index read-ahead planning portion 14, and an index read-in portion 15 which are all constructed by installing computer programs into the computation device. Further, the information search device 1 includes a data storage portion 20 in the storage device, i.e., an auxiliary storage device such as a hard disk drive or the like, so as to store the analytical data of search objects analyzed by the predetermined analytical engine. Further, the information search device 1 includes an index information database 24 and an index read-in history 25 in the storage device, i.e., the auxiliary storage device. Further, the information search device 1 includes a main storage portion 30, i.e., a DRAM (Dynamic Random Access Memory) to temporarily store part of the information in the data storage portion 20, in order to carry out a process of searching for the desired information from the data storage portion 20. Hereinbelow, each configuration will be described in detail.

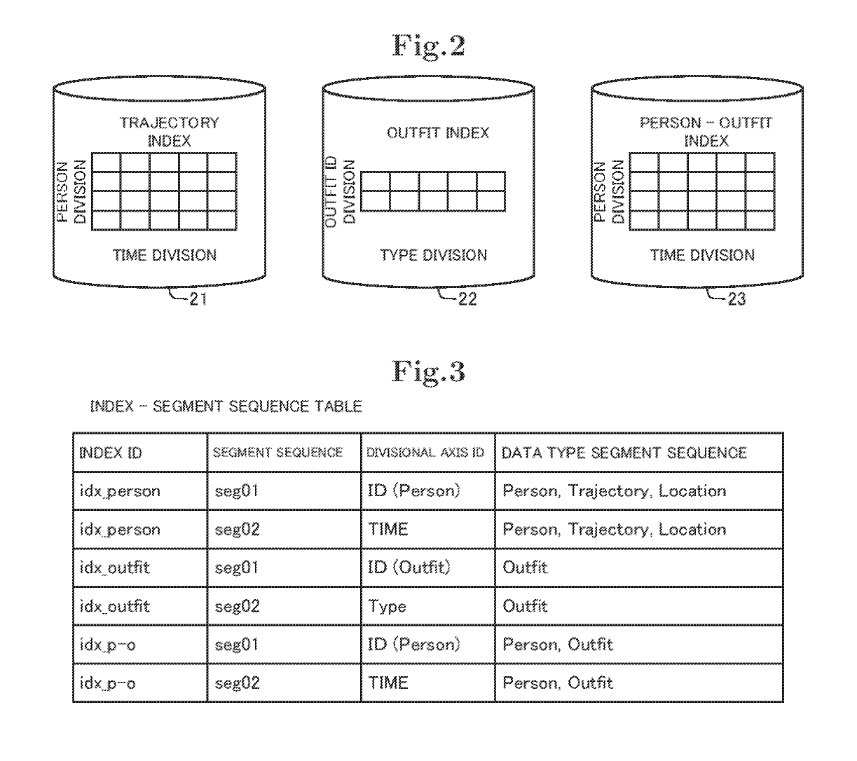

First, the data storage portion 20 stores the analytical data as described above. The analytical data in this exemplary embodiment is, for example, an “analysis result of motion lines of a person” obtained by analyzing the moving image taken within a predetermined range. In particular, it includes a “person” of the analysis object, “place” where that person is located, “time and date (time of day)”, “outfit” of the person, and the like. Then, the data storage portion 20 collectively stores the analytical data such as the information of the analysis object itself, the outfit of the person, and the like as described above, according to an “index” for each data. Hereinbelow, referring to FIG. 2, an example will be explained for the “index” of the analytical data in this exemplary embodiment.

First, the “index” of the analytical data has a trajectory index 21 denoting “person's trajectory” as the index of the analysis object. The trajectory index 21 stores information denoting the specific place of each person for each period of time, such as the information denoting “the person in x (place) from x (time) to x (time) on x (month) x (day). Then, the information in the trajectory index 21 is classified into the “segment” identified by the “period of time” and the “person”.

Further, the “index” of the analytical data has an outfit index 22 denoting the “outfit information” of each person as the index of related information which is the analysis result of each person of the analysis object. In particular, the outfit index 22 stores, for example, information denoting the “type” and “color” of the outfit of each person such as “gray jacket”, and being classified into the “segment” identified by the “type” of outfit, and the “ID for identifying outfit”.

Further, the “index” of the analytical data has a person-outfit index 23 which is information denoting the association between the “person” which is the aforementioned analysis object, and the “outfit information” which is associated information with the analysis object. In particular, the person-outfit index 23 stores information of associating “the person detected in an image from x (time) to x (time) on x (month)×(day)” with the “type and color of the outfit” of each person in the outfit index 22. Further, in the person-outfit index 23, the information is classified into “segment” identified by the “period of time” and “person”.

By using each of the indexes 21, 22 and 23 as above, first, the “person” present in the image of a predetermined time and date is identified form the trajectory index 21. Then, with the person-outfit index 23, it is possible to identify the “outfit information” associated with this “person”, and detect the ID for identifying the outfit from the outfit index 22 based on this “outfit information”.

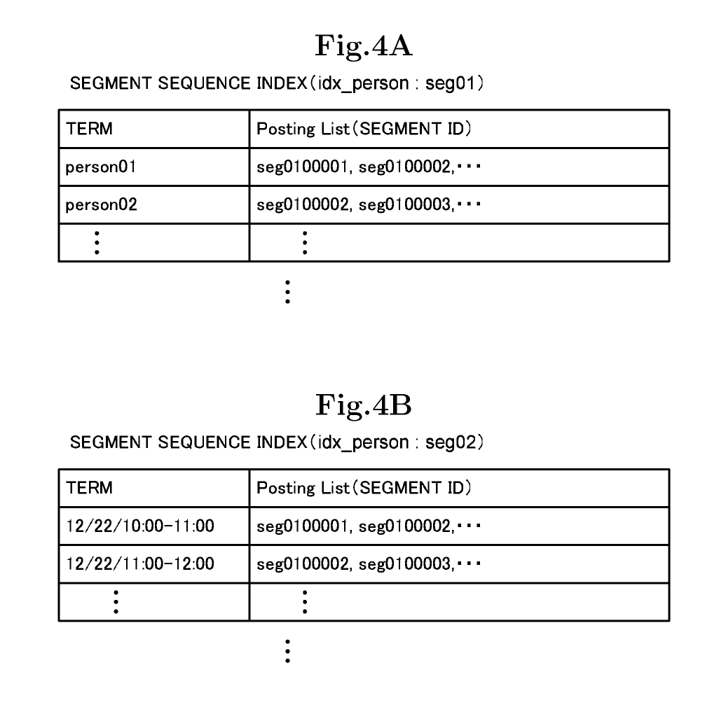

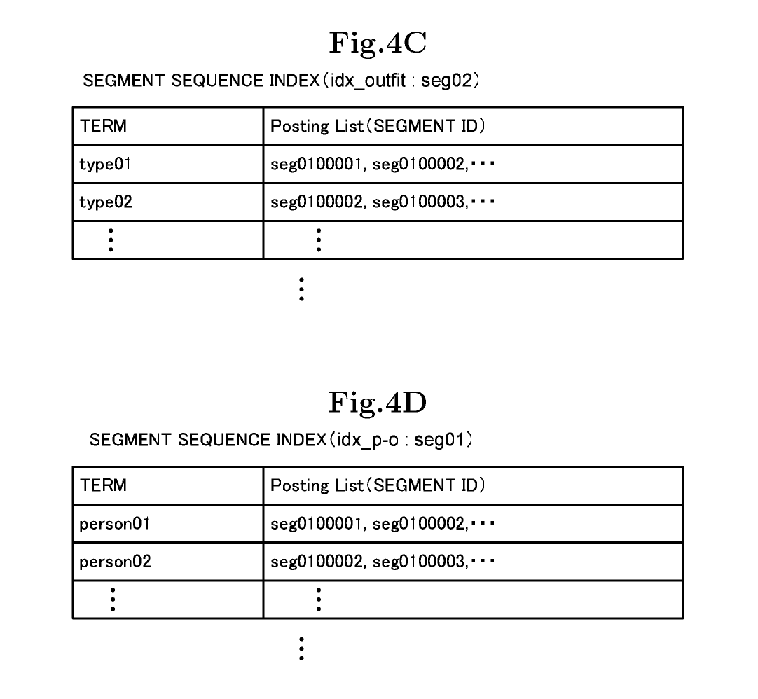

Further, the index information database 24 of the information search device 1 stores the meta-information of identifying each of the above indexes 21, 22 and 23, that is, the meta-information of identifying each segment into which each index is divided respectively under a predetermined condition. In particular, it stores an “index-segment sequence table” shown in FIG. 3, and a “segment sequence index” shown in FIGS. 4A to 4D.

First, the index-segment sequence table shown in FIG. 3 has an “index ID” for identifying the index. For example, it has information of “idx_person”, “idx_outfit”, and “idx_p-o” as the “index ID” denoting the trajectory index 21, outfit index 22, and person-outfit index 23, respectively. Further, the index-segment sequence table has a “data type” denoting the data content of each of the indexes 21, 22, and 23. For example, it has the information of “person, trajectory, location”, “outfit”, and “person, outfit”, as the “data type” denoting the data contents of the trajectory index 21, outfit index 22, and person-outfit index 23, respectively.

Further, the index-segment sequence table has a “divisional axis ID” denoting the divisional axis of each segment in each index, and a “segment sequence” denoting the sequence of dividing the respective segments corresponding to the divisional axis. For example, as described above, in the trajectory index 21, because the information is classified into the “segment” identified by the “time” and “person”, each segment is sorted into “seg01” and “seg02” denoting each sequence of the “person” and “time”, respectively. Likewise, in the outfit index 22, because the information is classified into the “segment” identified by the “ID for identifying color” of outfit, and “type” of outfit, each segment is sorted into “seg01” and “seg02” denoting each sequence of the “ID for identifying color” and “type”, respectively. Still likewise, in the person-outfit index 23, because the information is classified into the “segment” identified by the “time” and “person”, each segment is sorted into “seg01” and “seg02” denoting each sequence of the “person” and “time”, respectively.

Then, the segment sequence index shown in FIGS. 4A to 4D is information of identifying each segment included in the segment sequence of each index described above. For example, first, FIG. 4A is information of identifying each segment included in the segment sequence “seg01” when the “idx_person” of the trajectory index 21 is sorted by the person, and stores the segment (Posting List (segment ID)) corresponding to each person (term). To make a detailed description, in FIG. 4A, the person “person01” is associated with the segments “seg010001, seg010002, . . . ”, whereby it is possible to identify that the trajectory information of the person “person01” is included in the segments “seg010001, seg010002, . . . ”.

Further, FIG. 4A is information of identifying each segment included in the segment sequence “seg02” when the “idx_person” of the trajectory index 21 is sorted by the time, and stores the segment (Posting List (segment ID)) corresponding to each period of time (term). Further, FIG. 4C is information of identifying each segment included in the segment sequence “seg02” when the “idx_outfit” of the outfit index 22 is sorted by the type of outfit, and stores the segment (Posting List (segment ID)) corresponding to the type of each outfit (term). Further, FIG. 4D is information of identifying each segment included in the segment sequence “seg01” when the “idx_p-o” of the person-outfit index 23 is sorted by the person, and stores the segment (Posting List (segment ID)) corresponding to each person (term).

As will be described later, the aforementioned index read-in history 25 of the information search device 1 stores history information denoting the index segments which have already been read into the main storage portion 30. By referring to this index read-in history 25, the information search portion 13, the index read-in portion 15 and the like can recognize the index segments stored in the main storage portion 30, and can read additional segments into the main storage portion 30 as necessary for a new search.

Further, the main storage portion 30 of the information search device 1 is, also as will be described later, a storage device temporarily storing each segment read out of the data storage portion 20, i.e., each of the indexes 21, 22, and 23, by the index read-in portion 15 according to the commands from the information search portion 13 and index read-ahead planning portion 14 when searching for the desired information from the analytical data. Then, on this main storage portion 30, the search is performed by the information search portion 13 from the segments which are the indexes stored in the main storage portion 30.

Further, the request acceptance portion 11 (search request acceptance means) of the information search device 1 accepts search condition information denoting a search request of the analytical data from a client 2 which is an information processing device. As an example, the search condition information is such information as “the outerwear information for a person using the elevator from 11:00 to 12:00 on December 22”. Then, the request acceptance portion 11 passes the accepted search condition information to the request decomposition portion 12. With this, the request decomposition portion 12 decomposes the search condition information, according to a preset rule, into “a person using the elevator from 11:00 to 12:00 on December 22” of the part “object search condition information” which is the condition for identifying the “person” of the analysis object, and “the outerwear information of a person” of the part “search condition information for associated information” which is the condition for identifying the “associated information” of the “person” of the search object. Then, the request decomposition portion 12 returns the decomposition result to the request acceptance portion 11. By virtue of this, the request acceptance portion 11 can distinguish and recognize the search condition information between “a person using the elevator from 11:00 to 12:00 on December 22” of the part “object search condition information”, and “the outerwear information of a person” of the part “search condition information for associated information”. Further, the search condition information may also be inputted as being distinguished between “a person using the elevator from 11:00 to 12:00 on December 22” of the part “object search condition information”, and “the outerwear information of a person” of the part “search condition information for associated information”. In such case, the request acceptance portion 11 can accept the inputted search condition information as it is, being distinguished between the part “object search condition information” and the part “search condition information for associated information”.

Further, the information search portion 13, index read-ahead planning portion 14 and index read-in portion 15 (the search means) of the information search device 1 carries out a search of the analytical data corresponding to the relevant search condition according to the search condition information accepted as described above. At this time, the information search portion 13 carries out the search with two phases such as (phase 1) reading out the segments which are part of each index from the data storage portion 20 by the index read-in portion 15 and storing the same into the main storage portion 30 while carrying out the search for the analysis object and, thereafter, (phase 2) carrying out the search for the associated information of the analysis object.

In particular, in search for the analysis object at the first phase (1), first, the index read-in portion 15 identifies the segment including the “person” of the analysis object corresponding to the “object search condition information”, and reads out this segment from the trajectory index 21 to store the same into the main storage portion 30. Then, the information search portion 13 searches for the “person” of the analysis object corresponding to the “object search condition information” on the segments of the trajectory index 21 stored in the main storage portion 30. Further, receiving the search result of the “person” from the information search portion 13, the index read-in portion 15 reads out the segment, which is the information denoting the association between the relevant person to the searched “person”, and the outfit information, from the person-outfit index 23, so as to store the same into the main storage portion 30.

Then, in this exemplary embodiment, in parallel with the analysis object search process at the above first phase (1), the index read-ahead planning portion 14 and index read-in portion 15 further carry out a process of identifying the segment including the “outerwear information” which is the associated information corresponding to the “search condition information for associated information”, and reading out this segment from the outfit index 22 to store the same into the main storage portion 30.

Thereafter, the information search portion 13 searches for the “outerwear information” which is the associated information corresponding to the “search condition information for associated information”, of the “person” corresponding to the “object search condition information”, from each segment of each of the indexes 21, 22, and 23; that is, part of the information of each of the indexes 21, 22, and 23 stored in the main storage portion 30. Further, the specific processing content will be described in detail in the following explanation for operation.

[Operation]

Next, referring to FIGS. 5 through 7, the operation of the abovementioned information search device 1 will be explained. Further, the data storage portion 20 of the information search device 1 is supposed, as described above, to have stored the “analytical data of motion lines of person” organized by each of the indexes 21, 22, and 23.

First, the information search device 1 lets the request acceptance portion 11 accept the search condition information denoting a search request of the analytical data, inputted from the client 2 (Yes in step S1 of FIG. 5). Here, for example, it is supposed to have accepted such search condition information as “the outerwear information for a person using the elevator from 11:00 to 12:00 on December 22”. Then, via the request decomposition portion 12, the request acceptance portion 11 decomposes the above search condition information into “a person using the elevator from 11:00 to 12:00 on December 22” of the part “object search condition information” which is the condition for identifying the “person” of the analysis object, and “the outerwear information of a person” of the part “search condition information for associated information” which is the condition for identifying the “associated information” of the “person” of the search object (step S2 of FIG. 5). Then, the request acceptance portion 11 passes the search condition information, which is the part “object search condition information” and the part “search condition information for associated information”, to the information search portion 13.

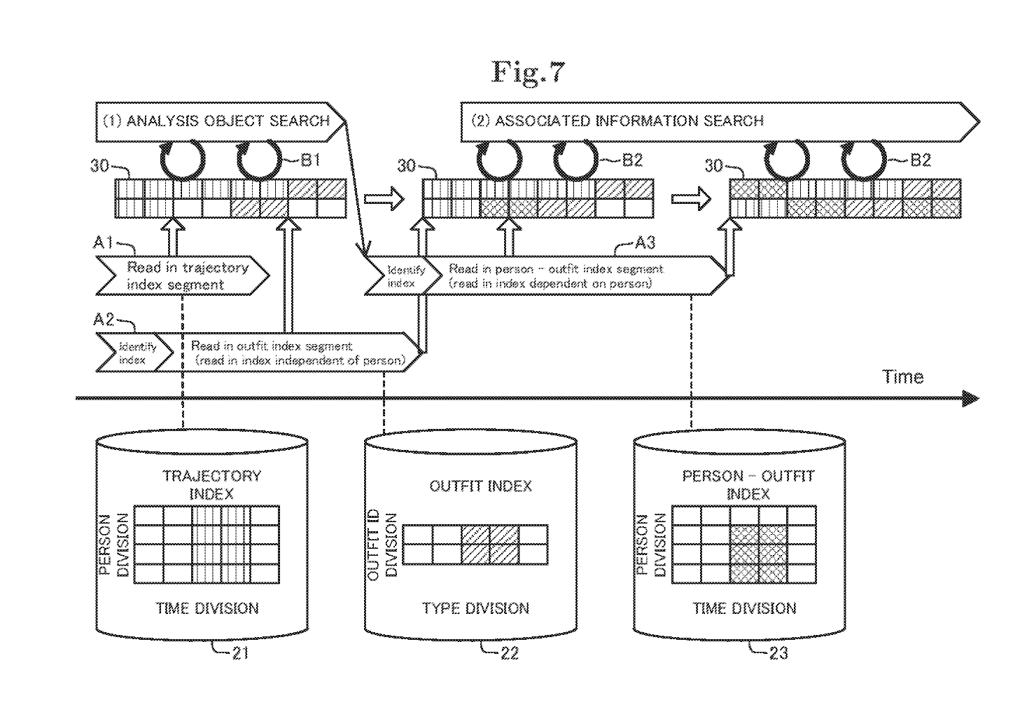

Next, the information search device 1 lets the information search portion 13, index read-ahead planning portion 14 and index read-in portion 15 carry out a search process, as shown in FIG. 7, with such two phases as: (1) the search process of the analysis object to search for “a person using the elevator from 11:00 to 12:00 on December 22” of the part “object search condition information” accepted, and (2) the search process of the associated information of the analysis object to search for “the outerwear information of a person” of the part “search condition information for associated information” accepted.

In particular, referring to FIG. 7, the processing content in each phase will be explained. Further, the numeral 30 in FIG. 7 denotes a snapshot image of a memory area in the main storage portion 30.

First, in (1) the analysis object search of the first phase, as shown by the symbol A1 of FIG. 7, the index read-in portion 15 identifies the segment including the “person” of the analysis object corresponding to the “object search condition information”, and reads out this segment from the trajectory index 21 to store the same into the main storage portion 30. For example, if the “object search condition information” is “a person using the elevator from 11:00 to 12:00 on December 22”, then the index read-in portion 15 first identifies the segment including the “person” detected in the period of time from 11:00 to 12:00 on December 22”. Therefore, it identifies the segment sequence “seg02” wherein the “divisional axis ID” is the “time” among the trajectory index “idx_person” wherein the “data type segment sequence” is the “person, trajectory, location”, from the index-segment sequence table shown in FIG. 3. Then, it identifies the “segment” wherein the “term” is associated with “11:00 to 12:00 on December 22” from the segment sequence index corresponding to this segment sequence “seg02” as shown in FIG. 4B, and reads out this “segment” from the trajectory index 21 to store the same into the main storage portion 30. With this, among the segments in the trajectory index 21 shown in FIG. 7, the part displayed in vertical lines is stored in the main storage portion 30.

Subsequently, in (1) the analysis object search, the information search portion 13 searches for the “person” located in the “elevator” corresponding to the “object search condition information”, as shown by the symbol B1 of FIG. 7, with respect to the segments of the trajectory index 21 stored in the main storage portion 30. In this manner, it first searches for “a person using the elevator from 11:00 to 12:00 on December 22” of the analysis object satisfying the search request (step S3 of FIG. 5).

Still subsequently, in (1) the analysis object search, as shown by the symbol A3 of FIG. 7, the index read-in portion 15 reads out, from the person-outfit index 23, the segment including information denoting the association between the outfit information, and the person corresponding to the “person” searched by the information search portion 13, so as to store the same into the main storage portion 30. In this case, because of needing the information corresponding to the searched “person”, it first identifies the segment sequence “seg02” which is the “ID (person)” wherein the “divisional axis ID” denotes the person among the person-outfit index “idex_p-o” wherein the “data type segment sequence” is the “person, outfit”, from the index-segment sequence table shown in FIG. 3 (step S4 of FIG. 5). Then, it identifies the “segment” wherein the “term” is the searched “person (person01, . . . )” from the segment sequence index corresponding to this segment sequence “seg02” as shown in FIG. 4D, and reads out this “segment” form the person-outfit index 23 to store the same into the main storage portion 30 (step S5 of FIG. 5). With this, among the segments in the person-outfit index 23 shown in FIG. 7, the hatched part is stored in the main storage portion 30.

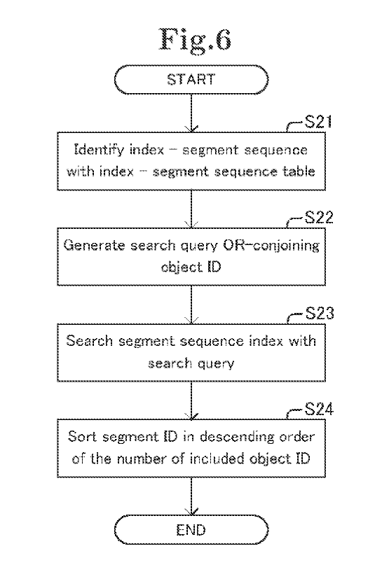

Here, when storing the segment from the person-outfit index 23 into the main storage portion 30, the segment to be stored into the main storage portion 30 may also be identified in the following manner. In particular, first, in the same manner as described above, the index read-in portion 15 identifies the segment sequence “seg02” wherein the “divisional axis ID” is the “ID (person)” denoting the person among the person-outfit index “idx_p-o” wherein the “data type segment sequence” is the “person, outfit”, from the index-segment sequence table shown in FIG. 3 (step S21 of FIG. 6). Then, it generates a search query which has conjoined through logical addition (OR conjunction) all the “ID” (object IDs) of the “person” searched by the information search portion 13 (step S22 of FIG. 6), and searches with this search query from the segment sequence index corresponding to the segment sequence “seg02” as shown in FIG. 4D (step S23 of FIG. 6). That is, it searches for the “segment” wherein the “ID” of the “person” searched by the information search portion 13 is included in the “term”. Thereafter, it sorts the segment IDs in descending order of the number of the included “ID” (object IDs) of the “person” searched by the information search portion 13 (step S24 of FIG. 6), and preferentially stores the anterior segments into the main storage portion 30. That is, it preferentially stores, into the main storage portion 30, the “segment” including more “person” searched by the information search portion 13, in the person-outfit index 23.

Then, in (1) the analysis object search process, in parallel with carrying out this analysis object search process, as shown by the symbol A2 of FIG. 7, the index read-ahead planning portion 14 and index read-in portion 15 carry out a process of identifying the segment including the associated information corresponding to the “search condition information for associated information”, and reading out this segment from the outfit index 22 to store the same into the main storage portion 30. That is, from starting the segment read-in from the trajectory index 21 shown by the symbol A1 of FIG. 7, in parallel with carrying out the person search process shown by the symbol B1, and the segment read-in process from the person-outfit index 23 shown by the symbol A3, it carries out a read-ahead of the segment including the associated information corresponding to the “search condition information for associated information”.

For example, if the “search condition information for associated information” is the “outfit information of a person”, then the index read-ahead planning portion 14 first identifies the information wherein the outfit is “outerwear” (step S7 of FIG. 5). Accordingly, the index read-ahead planning portion 14 identifies the segment sequence “seg02” which is the “type” wherein the “divisional axis ID” denotes an outfit type in the trajectory index “idex_outfit” wherein the “data type segment sequence” is “outfit”, from the index-segment sequence table shown in FIG. 3. Then, the index read-ahead planning portion 14 identifies the “segment” wherein the “term” is the “outerwear (type01, for example)” from the segment sequence index corresponding to this segment sequence “seg02” as shown in FIG. 4C. Thereafter, the index read-in portion 15 reads out this identified segment from the outfit index 22 to store the same into the main storage portion 30 (step S8 of FIG. 5). With this, among the segments in the outfit index 22 shown in FIG. 7, the part in diagonal lines is stored in the main storage portion 30.

In this manner, the information search device 1 in accordance with the present invention carries out a process of storing the information related to the “outerwear”, which is the “associated information” of the relevant search object, into the main storage portion 30 before identifying the “person” of the “search object”.

Then, as described above, after storing, into the main storage portion 30, all of the segments including the “outerwear information” corresponding to the “search condition information for associated information” (Yes in step S6 of FIG. 5), the information search portion 13 carries out the second phase: (2) the associated information search process (step S9 of FIG. 5). However, (2) the associated information search process is not limited to being started after storing, into the main storage portion 30, all of the segments including the “outerwear information” corresponding to the “search condition information for associated information”. (2) The associated information search process may also be started before storing, into the main storage portion 30, all of the segments including the “outerwear information” corresponding to the “search condition information for associated information”.

Further, as shown by the symbol A3 of FIG. 7, (2) the associated information search process may also be started just when the index read-in portion 15 reads out, from the person-outfit index 23, the segment including the information denoting the association between the outfit information, and the relevant person corresponding to the “person” searched by the information search portion 13, so as to store the same into the main storage portion 30. In such case, while carrying out the search process for the associated information by using the segment from the person-outfit index 23 already stored in the main storage portion 30, another process is carried out in parallel to read out the residual segments from the person-outfit index 23 and store the same into the main storage portion 30 (step S10 of FIG. 5).

In particular, (2) the associated information search process first searches for the information corresponding to the “person” searched in (1) the analysis object search process from the segments stored into the main storage portion 30 from the person-outfit index 23. Then, because it is possible to identify the outfit information associated with the “person” searched in (1) the analysis object search process, with this outfit information as the key, the outfit information is searched for from inside the segments stored into the main storage portion 30 from the outfit index 22 as described above (the symbol B2 of FIG. 7 for step S9 of FIG. 5). By virtue of this, it is possible to search for the information corresponding to “the outerwear information for a person using the elevator from 11:00 to 12:00 on December 22” which is the search request.

In the above manner, in the information search device 1 in accordance with the present invention, the search request is divided into the “object search condition information” and the “search condition information for associated information”; in (1) the analysis object search process, from before searching the “person” corresponding to the “object search condition information”, the segment of the outfit index 22, which includes the “associated information” corresponding to the “search condition information for associated information” independent of that object, is read into the main storage portion 30 beforehand. That is, in parallel with the process of searching for the “person” of the analysis object, another process is carried out to read the “associated information” of each person into the main storage portion 30. Therefore, compared with the case of reading the segment including the “associated information” corresponding to the relevant “person” from the outfit index 22 into the main storage portion 30 after searching for the “person”, it is possible to reduce the read-in time. As a result, it is possible to facilitate speed-up of the search process itself of the analytical data.

<Supplementary Notes>

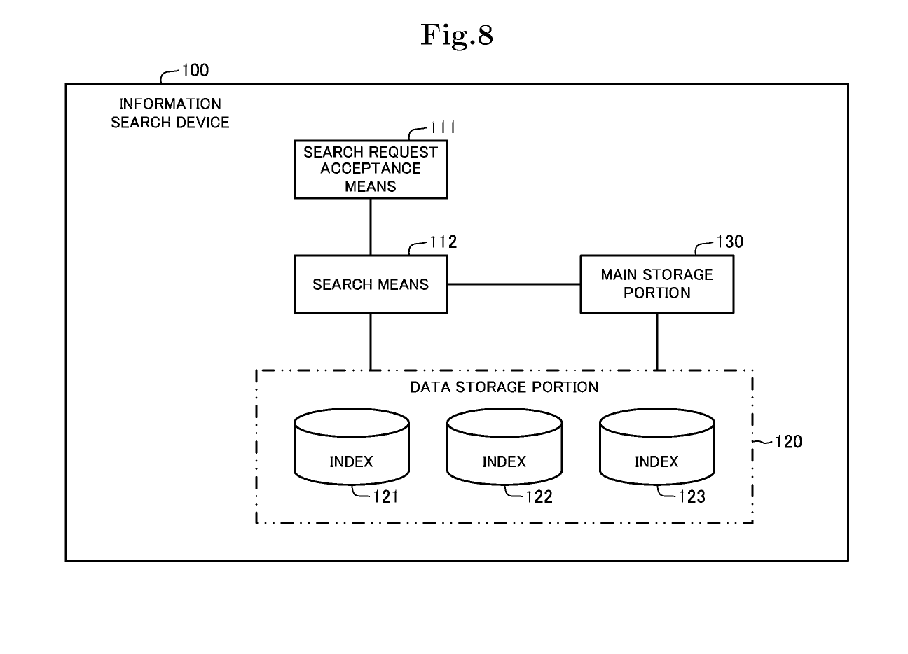

The whole or part of the exemplary embodiment disclosed above can be described as the following supplementary notes. Hereinbelow, an outline of the configuration of an information search device in accordance with the present invention will be explained with reference to FIG. 8. However, the present invention is not limited to following configuration.

(Supplementary Note 1)

An information search device 100 comprising:

a data storage portion 120 having stored an index 121 of analysis object information, an index 122 of associated information which is a predetermined analysis result for each analysis object, and an index 123 associating the analysis object information with the associated information of the analysis object;

a main storage portion 130 temporarily storing the respective indexes read out from the data storage portion;

a search request acceptance means 111 for accepting search condition information denoting a search request of the information to be searched for from the data storage portion; and

a search means 112 for reading out at least some of the respective indexes from the data storage portion to store the same into the main storage portion based on the search condition information, and searching for the information corresponding to the search condition information from the respective indexes stored in the main storage portion,

wherein the search request acceptance means 111 accepts, as the search condition information, object search condition information which is the condition for identifying the analysis object, and associated information search condition information which is the condition for identifying the associated information,

wherein the search means 112 stores, into the main storage portion from the data storage portion, the index of the analysis object information including the analysis object corresponding to the object search condition information, and the index of the associated information including the associated information corresponding to the associated information search condition information; searches for the analysis object identified by the object search condition information from the main storage portion and stores, into the main storage portion, the index associating the associated information with the analysis object information corresponding to the searched analysis object; and searches for the information corresponding to the search condition information from the respective indexes stored in the main storage portion.

(Supplementary Note 2)

The information search device according to Supplementary Note 1, wherein while carrying out the process of storing, into the main storage portion, the index of the analysis object information including the analysis object corresponding to the object search condition information, the process of searching for the analysis object identified by the object search condition information from the main storage portion, and the process of storing, into the main storage portion, the index associating the associated information with the analysis object information corresponding to the searched analysis object, the search means stores, into the main storage portion, the index of the associated information including the associated information corresponding to the associated information search condition information.

(Supplementary Note 3)

The information search device according to Supplementary Note 2, wherein the search means searches for the information corresponding to the search condition information from the respective indexes stored in the main storage portion after storing, into the main storage portion, all of the indexes of the associated information including the associated information corresponding to the associated information search condition information.

(Supplementary Note 4)

The information search device according to any one of Supplementary Notes 1 to 3, wherein meta-information is stored to identify each segment into which each of the indexes is divided under a predetermined condition respectively; and based on the meta-information, the search means identifies and stores, into the main storage portion, the segments of the index of the analysis object information including the analysis object corresponding to the object search condition information, the segments of the index of the associated information including the associated information corresponding to the associated information search condition information, and the segments of the index associating the associated information with the analysis object information corresponding to the searched analysis object.

(Supplementary Note 5)

The information search device according to Supplementary Note 4, wherein the search means preferentially stores, into the main storage portion, the segments of the index associating the associated information with the analysis object information including more analysis object information corresponding to the searched analysis object.

(Supplementary Note 6)

A computer program comprising instructions for causing an information processing device to realize a function,

the information processing device comprising:

a data storage portion having stored an index of analysis object information, an index of associated information which is a predetermined analysis result for each analysis object, and an index associating the analysis object information with the associated information of the analysis object; and

a main storage portion temporarily storing the respective indexes read out from the data storage portion,

the function comprising:

a search request acceptance means for accepting search condition information denoting a search request of the information to be searched for from the data storage portion; and

a search means for reading out at least some of the respective indexes from the data storage portion to store the same into the main storage portion based on the search condition information, and searching for the information corresponding to the search condition information from the respective indexes stored in the main storage portion,

wherein the search request acceptance means accepts, as the search condition information, object search condition information which is the condition for identifying the analysis object, and associated information search condition information which is the condition for identifying the associated information,

wherein the search means stores, into the main storage portion from the data storage portion, the index of the analysis object information including the analysis object corresponding to the object search condition information, and the index of the associated information including the associated information corresponding to the associated information search condition information; searches for the analysis object identified by the object search condition information from the main storage portion and stores, into the main storage portion, the index associating the associated information with the analysis object information corresponding to the searched analysis object; and searches for the information corresponding to the search condition information from the respective indexes stored in the main storage portion.

(Supplementary Note 7)

The computer program according to Supplementary Note 6, wherein while carrying out the process of storing, into the main storage portion, the index of the analysis object information including the analysis object corresponding to the object search condition information, the process of searching for the analysis object identified by the object search condition information from the main storage portion, and the process of storing, into the main storage portion, the index associating the associated information with the analysis object information corresponding to the searched analysis object, the search means stores, into the main storage portion, the index of the associated information including the associated information corresponding to the associated information search condition information.

(Supplementary Note 8)

An information search method for the use of an information processing device including a data storage portion having stored an index of analysis object information, an index of associated information which is a predetermined analysis result for each analysis object, and an index associating the analysis object information with the associated information of the analysis object, and a main storage portion temporarily storing the respective indexes read out from the data storage portion, the method comprising:

accepting object search condition information which is the condition for identifying the analysis object, and associated information search condition information which is the condition for identifying the associated information, as search condition information denoting a search request of the information to be searched for from the data storage portion; and

storing, into the main storage portion from the data storage portion, the index of the analysis object information including the analysis object corresponding to the object search condition information, and the index of the associated information including the associated information corresponding to the associated information search condition information, searching for the analysis object identified by the object search condition information from the main storage portion and storing, into the main storage portion, the index associating the associated information with the analysis object information corresponding to the searched analysis object, and searching for the information corresponding to the search condition information from the respective indexes stored in the main storage portion, when reading out at least some of the respective indexes from the data storage portion to store the same into the main storage portion based on the search condition information, and searching for the information corresponding to the search condition information from the respective indexes stored in the main storage portion.

(Supplementary Note 9)

The information search method according to Supplementary Note 8, wherein when reading out at least some of the respective indexes from the data storage portion to store the same into the main storage portion based on the search condition information, the index of the associated information, which includes the associated information corresponding to the associated information search condition information, is stored into the main storage portion, while carrying out the process of storing, into the main storage portion, the index of the analysis object information including the analysis object corresponding to the object search condition information, the process of searching for the analysis object identified by the object search condition information from the main storage portion, and the process of storing, into the main storage portion, the index associating the associated information with the analysis object information corresponding to the searched analysis object.

Further, the computer program in the above each exemplary embodiment is stored either in a storage device or in a recording medium readable by a computer. The recording medium is, for example, a portable medium such as a flexible disk, optical disk, magnetic optical disk, semiconductor memory, or the like.

Hereinabove, the present invention is explained in reference to the above each exemplary embodiment. However, the present invention is not limited to the above exemplary embodiment. It is possible to apply various changes understandable by those skilled in the art to the configuration and details of the present invention within the scope of the present invention.

Further, the present application claims priority from Japanese Patent Application No. 2011-12711, filed on Jan. 25, 2011 in Japan, the disclosure of which is incorporated herein by reference in its entirety.

### REFERENCE SIGNS LIST

1 Information search device
2 Client
11 Request acceptance portion
12 Request decomposition portion
13 Information search portion
14 Index read-ahead planning portion
15 Index read-in portion
20 Data storage portion
21 Trajectory index
22 Outfit index
23 Person-outfit index
24 Index information database
25 Index read-in history
30 Main storage portion
100 Information search device
111 Search request acceptance means
112 Search means
120 Data storage portion
121, 122, 123 Indexes
130 Main storage portion

1. An information search device comprising:
a data storage portion having stored an index of analysis object information, an index of associated information which is a predetermined analysis result for each analysis object, and an index associating the analysis object information with the associated information of the analysis object;
a main storage portion temporarily storing the respective indexes read out from the data storage portion;
a search request acceptance unit for accepting search condition information denoting a search request of the information to be searched for from the data storage portion; and
a search unit for reading out at least some of the respective indexes from the data storage portion to store the same into the main storage portion based on the search condition information, and searching for the information corresponding to the search condition information from the respective indexes stored in the main storage portion,
wherein the search request acceptance unit accepts, as the search condition information, object search condition information which is the condition for identifying the analysis object, and associated information search condition information which is the condition for identifying the associated information,
wherein the search unit stores, into the main storage portion from the data storage portion, the index of the analysis object information including the analysis object corresponding to the object search condition information, and the index of the associated information including the associated information corresponding to the associated information search condition information; searches for the analysis object identified by the object search condition information from the main storage portion and stores, into the main storage portion, the index associating the associated information with the analysis object information corresponding to the searched analysis object; and searches for the information corresponding to the search condition information from the respective indexes stored in the main storage portion.

2. The information search device according to claim 1, wherein while carrying out the process of storing, into the main storage portion, the index of the analysis object information including the analysis object corresponding to the object search condition information, the process of searching for the analysis object identified by the object search condition information from the main storage portion, and the process of storing, into the main storage portion, the index associating the associated information with the analysis object information corresponding to the searched analysis object, the search unit stores, into the main storage portion, the index of the associated information including the associated information corresponding to the associated information search condition information.

3. The information search device according to claim 2, wherein the search unit searches for the information corresponding to the search condition information from the respective indexes stored in the main storage portion after storing, into the main storage portion, all of the indexes of the associated information including the associated information corresponding to the associated information search condition information.

4. The information search device according to claim 1, wherein meta-information is stored to identify each segment into which each of the indexes is divided under a predetermined condition respectively; and based on the meta-information, the search unit identifies and stores, into the main storage portion, the segments of the index of the analysis object information including the analysis object corresponding to the object search condition information, the segments of the index of the associated information including the associated information corresponding to the associated information search condition information, and the segments of the index associating the associated information with the analysis object information corresponding to the searched analysis object.

5. The information search device according to claim 4, wherein the search unit preferentially stores, into the main storage portion, the segments of the index associating the associated information with the analysis object information including more analysis object information corresponding to the searched analysis object.

6. A non-transitory computer-readable medium storing a computer program comprising instructions for causing an information processing device to realize a function,
the information processing device comprising:
a data storage portion having stored an index of analysis object information, an index of associated information which is a predetermined analysis result for each analysis object, and an index associating the analysis object information with the associated information of the analysis object; and
a main storage portion temporarily storing the respective indexes read out from the data storage portion,
the function comprising:
a search request acceptance unit for accepting search condition information denoting a search request of the information to be searched for from the data storage portion; and
a search unit for reading out at least some of the respective indexes from the data storage portion to store the same into the main storage portion based on the search condition information, and searching for the information corresponding to the search condition information from the respective indexes stored in the main storage portion,
wherein the search request acceptance unit accepts, as the search condition information, object search condition information which is the condition for identifying the analysis object, and associated information search condition information which is the condition for identifying the associated information,
wherein the search unit stores, into the main storage portion from the data storage portion, the index of the analysis object information including the analysis object corresponding to the object search condition information, and the index of the associated information including the associated information corresponding to the associated information search condition information; searches for the analysis object identified by the object search condition information from the main storage portion and stores, into the main storage portion, the index associating the associated information with the analysis object information corresponding to the searched analysis object; and searches for the information corresponding to the search condition information from the respective indexes stored in the main storage portion.

7. The non-transitory computer-readable medium storing the computer program according to claim 6, wherein while carrying out the process of storing, into the main storage portion, the index of the analysis object information including the analysis object corresponding to the object search condition information, the process of searching for the analysis object identified by the object search condition information from the main storage portion, and the process of storing, into the main storage portion, the index associating the associated information with the analysis object information corresponding to the searched analysis object, the search unit stores, into the main storage portion, the index of the associated information including the associated information corresponding to the associated information search condition information.

8. An information search method for the use of an information processing device including a data storage portion having stored an index of analysis object information, an index of associated information which is a predetermined analysis result for each analysis object, and an index associating the analysis object information with the associated information of the analysis object, and a main storage portion temporarily storing the respective indexes read out from the data storage portion, the method comprising:
accepting object search condition information which is the condition for identifying the analysis object, and associated information search condition information which is the condition for identifying the associated information, as search condition information denoting a search request of the information to be searched for from the data storage portion; and
storing, into the main storage portion from the data storage portion, the index of the analysis object information including the analysis object corresponding to the object search condition information, and the index of the associated information including the associated information corresponding to the associated information search condition information, searching for the analysis object identified by the object search condition information from the main storage portion and storing, into the main storage portion, the index associating the associated information with the analysis object information corresponding to the searched analysis object, and searching for the information corresponding to the search condition information from the respective indexes stored in the main storage portion, when reading out at least some of the respective indexes from the data storage portion to store the same into the main storage portion based on the search condition information, and searching for the information corresponding to the search condition information from the respective indexes stored in the main storage portion.

9. The information search method according to claim 8, wherein when reading out at least some of the respective indexes from the data storage portion to store the same into the main storage portion based on the search condition information, the index of the associated information, which includes the associated information corresponding to the associated information search condition information, is stored into the main storage portion, while carrying out the process of storing, into the main storage portion, the index of the analysis object information including the analysis object corresponding to the object search condition information, the process of searching for the analysis object identified by the object search condition information from the main storage portion, and the process of storing, into the main storage portion, the index associating the associated information with the analysis object information corresponding to the searched analysis object.
